(19) United States
(12) Patent Application Publication
(10) Pub. No.: US 2021/0040000 A1
(43) Pub. Date: Feb. 11, 2021

(54) DISPERSANT FOR REDUCING THE MIXING TIMES OF MINERAL BINDER SYSTEMS

(71) Applicant: SIKA TECHNOLOGY AG, Baar (CH)

(72) Inventors: Jürg WEIDMANN, Winterthur (CH); Jörg ZIMMERMANN, Winterthur (CH); Fabia ULBER, Tagelswangen (CH)

(73) Assignee: SIKA TECHNOLOGY AG, Baar (CH)

(21) Appl. No.: 16/964,048

(22) PCT Filed: Jan. 22, 2019
(86) PCT No.: PCT/EP2019/051413

§ 371 Date: Jul. 22, 2020

(30) Foreign Application Priority Data
Jan. 24, 2018 (EP) 18153320.9

(51) Int. Cl. C04B 40/00; C04B 24/26; C04B 28/02

(52) U.S. Cl. CPC C04B 40/0039; C04B 2103/006; C04B 28/02; C04B 24/2647

(57) ABSTRACT

Methods of using a comb polymer K for reducing the mixing time of a mineral binder composition with water, where the comb polymer K has a polymer backbone and side chains, and the comb polymer K includes at least one monomeric unit M1, including acid groups, and at least one monomeric unit M2, including side chains, the monomeric units M1 and M2 being arranged in a non-statistical sequence along the polymer backbone.

### TECHNICAL FIELD

The invention relates to the use of a comb polymer as dispersant in mineral binder compositions. The invention further relates to a process for producing mortar and concrete with a shortened mixing time.

### PRIOR ART

Concrete and mortar are used worldwide as building materials. These are essentially mixtures of mineral binders, usually cement, with sand and gravel. As a result of mixing with water, the cement cures in a chemical reaction to form hydrates (also referred to as hydrated cement) and produces a solid structure of hydrated cement, sand and gravel.

In recent years, specialty concretes such as self-compacting concrete (SCC), high performance concrete (HPC) and ultrahigh performance concrete (UHPC) and also high performance and ultrahigh performance mortar have appeared on the market. SCC is a concrete having self-compacting properties which flows very well without demixing. SCC can be introduced without being vibrated into formwork, as a result of which fabrication is assisted and noise pollution and possible damage to the health of the processor are reduced.

HPC and UHPC display very good processability, high strengths of more than 60 MPa or more than 80 MPa and above and high durability. High performance and ultrahigh performance concretes allow significantly smaller component dimensions, which saves space and reduces transport costs.

The specialty concretes and mortars contain a high proportion of mineral binder and of fines below 0.125 mm. This high proportion of flour particles, i.e. the sum of all fines including cement and other mineral binders, having particle sizes below 0.125 mm is characteristic of SCC, HPC and UHPC. The high proportion of fines results in good homogeneity of the concretes and the high proportion of mineral binder results in high strength. High performance concretes and mortars additionally have little to very little water because water which is not required for hydration of cement is vaporized and leaves behind pores which reduce the strength. In the case of standard concrete, the W/C value, i.e. the mass ratio of water to cement, is usually in the range from 0.45 to 0.60, while in the case of HPC and UHPC the W/C is significantly lower at less than 0.40, often less than 0.30 or 0.25. The W/C in the case of SCC is likewise low because too much water can lead to inhomogeneity, bleeding of cement paste and sedimentation, which adversely affects the self-compacting properties.

Concrete and mortar having a high fines content and little water are generally sticky and difficult to process and can only be processed with addition of particularly effective dispersants.

In addition, these concretes and mortars have to be mixed for a long time in order to achieve homogeneous distribution and wetting of all constituents. While standard concrete is often mixed for only 20 to 40 seconds in concrete works, a UHPC, for example, has to be intensively mixed for a number of minutes, in some cases up to 10 minutes or more, before it attains a readily processible consistency. This is a great disadvantage of these specialty concretes and restricts their use because long mixing time costs energy and significantly reduces productivity. Excessively long mixing time can in the case of concrete and mortar mixtures also lead to an undesirable increase in the temperature because of the low water content and the high shear forces. This can significantly decrease the time for which the mixtures remain processible. Dispersants or fluidizers are used in the building industry as plasticizers or water-reducing agents for mineral binder compositions. The dispersants are generally organic polymers which are added to the mixing water or are added as solid to the binder compositions. In this way, both the consistency of the binder composition during processing and also the properties in the cured state can be altered advantageously. Comb polymers based on polycarboxylates, for example, are known as particularly effective dispersants. Such comb polymers have a polymer backbone with acid groups and polyether side chains. They are usually produced by means of free-radical copolymerization of monomers which contain acid groups and of monomers which contain polyether chains.

Such polymers are described, for example, in EP 2522680 A1. A further possibility for producing them is a polymer-analogous esterification and/or amidation of polymers containing carboxyl groups with polyethers having a hydroxyl group or an amino group at one end. Such polymers are described, for example, in EP 1138697 A1.

In these comb polymers, the acid groups and the side chains are randomly distributed along the polymer backbone.

Conventional comb polymers as are used in the building industry as very effective fluidizers can sometimes readily fluidize SCC, HPC and UHPC, but even when these are used the concrete has to be mixed for a very long time until it is homogeneous and readily processible.

WO2015/144886 describes a block copolymer as dispersant for mineral binder compositions, which makes effective fluidization and good processing possible without greatly impairing the setting behavior.

WO 2017/050907 describes a copolymer having a gradient structure as dispersant for mineral binder compositions, which makes effective fluidization and good processing possible and maintains the effect over a very long time.

The prior art to date does not disclose any inexpensive and simple solution for reducing the mixing times, in particular of mineral binder compositions having a high content of cement and/or flour particles and a small amount of water.

For this reason, there continues to be a need for a simple solution, if possible in respect of a dispersant, which largely overcomes the disadvantages in the production of concrete or mortar having a high content of cement and/or flour particles and a small amount of water, in particular in the case of SCC, HPC, UHPC and high performance and ultrahigh performance mortars, especially the long mixing times.

### BRIEF DESCRIPTION OF THE INVENTION

It is therefore an object of the present invention to provide a dispersant which makes targeted shortening of the mixing time of mineral binder compositions possible, without having an adverse effect on the other properties, for example the slump, the strength or the duration of processability. In addition, the dispersant should preferably be able to be used with other admixtures. The dispersant should, in particular, be suitable for high performance (HPC) and ultrahigh performance concrete (UHPC) and high performance and ultrahigh performance mortar and for self-compacting concrete (SCC).

This object is surprisingly achieved by a process as described in claim 1.

The key aspect of the invention is the use of a comb polymer K for shortening the mixing time of a mineral binder composition with water, wherein the comb polymer K has a polymer backbone and side chains, wherein the comb polymer K comprises at least one monomer unit M1 comprising acid groups and at least one monomer unit M2 comprising side chains, wherein the monomer units M1 and M2 are arranged in a nonrandom sequence along the polymer backbone.

As has surprisingly been found, mineral binder compositions require, especially when they have a high content of cement and/or flour particles and have a small amount of water, a significantly shorter mixing time until they are homogeneous and flowable when they contain a comb polymer K having a nonrandom sequence of the monomer units along the polymer backbone than compositions containing conventional comb polymers. It is also particularly surprising that good processability, a long processing window and good strength development of the binder compositions are achieved despite the shortening of the mixing time.

In addition, it has been found that such comb polymers K having a nonrandom sequence of the monomer units along the polymer backbone are readily compatible with other admixtures, e.g. further dispersants, even in such mineral binder compositions.

Further aspects of the invention are subject matter of further independent claims. Particularly preferred embodiments of the invention are subject matter of the dependent claims.

Ways Of Carrying Out The Invention

The invention provides for the use of a comb polymer K for shortening the mixing time of a mineral binder composition with water, where the mixing time is shortened compared to the mixing time of an identical mineral binder composition containing a comb polymer having a random sequence of the monomer units along the polymer backbone and no comb polymer K, wherein the binder compositions have a comparably good processability after the end of the mixing time, wherein the comb polymer K has a polymer backbone and side chains, where the comb polymer K comprises at least one monomer unit M1 comprising acid groups and at least one monomer unit M2 comprising side chains, wherein the monomer units M1 and M2 are arranged in a nonrandom sequence along the polymer backbone.

In the present document, the “mixing time” is the time interval between the addition of water to the dry mineral binder composition and attainment of a homogeneous mixture. Here, a homogeneous mixture is a mixture which is free of unwetted powders, lumps and other compacted materials. In particular, the homogeneous mixture is flowable.

The point in time at which a homogeneous mixture is attained can be determined by different methods.

Firstly, a trained person skilled in the art can determine by looking at the mixed binder composition whether or not it is homogeneous. The person can estimate the mixing resistance and flow behavior by moving a shovel manually through the mixture and in this way assess the completeness or lack thereof of the mixing.

Secondly, a mixing tool can be equipped with a power meter. Here, the power required for a prescribed speed of rotation usually increases at the beginning of mixing and then drops to a relatively stable value as soon as the mixture is homogeneous and the mixing operation is complete.

In the present document, a “mineral binder composition” is a composition which contains at least one mineral binder.

In the present document, “flour particles” are the fines in a mineral binder composition. In general, the maximum particle diameter of the flour particles, for example determined by sieve analysis, is less than 0.125 mm. The flour particles here encompass cement, fly ash, slag sand, metakaolin, silica dust, quartz flour, fine calcium carbonate and/or inert ground rock and further fine mineral powders having a maximum particle diameter of less than 0.125 mm which are present in the binder composition.

In the present document, the expression “nonrandom sequence of the monomer units” refers to a distribution of the monomer units which is not obtained randomly. This means that it is not obtained under the usual conditions of a free-radical copolymerization or a polymer-analogous reaction. At least one monomer unit is present in a greater concentration in at least one section of the polymer backbone in the case of the nonrandom sequence. Copolymers of this type are, for example, block copolymers or copolymers having a gradient structure.

Analogously, the expression “random sequence of the monomer units” refers to a distribution of the monomer units which arises randomly, according to the reactivities of the monomers. A random sequence of the monomer units is obtained under the usual conditions of a free-radical copolymerization or a polymer-analogous reaction.

The use of the comb polymer K makes a shortened mixing time of a mineral binder composition with water possible. The mixing time is, in particular, shortened in comparison with a comparative mixture containing a comb polymer having a random sequence of the monomer units and no comb polymer K. Here, the mineral binder composition containing the comb polymer K and the comparative mixture have a comparably good processability at the end of the mixing time.

In particular, the mixing time is reduced by at least 20%, preferably at least 25%, especially at least 30%, compared to a mixing time of the mineral binder composition containing a comb polymer having a random sequence of the monomer units along the polymer backbone and no comb polymer K, with the binder compositions mixed with water having identical compositions except for the comb polymer and a comparably good processability after the end of the mixing time.

In particular, the use of the comb polymer K is particularly effective when the comparative mixture containing a comb polymer having a random sequence of the monomer units along the polymer backbone has a mixing time of more than 3 minutes, in particular more than 4 minutes.

A comparably good processability is present when the slump flow, measured in accordance with JIS A 1150, of the mineral binder compositions after the end of the mixing time is at least 55 cm and the difference between the slump flow values of the binder compositions is not more than 12 cm, with both mixtures having the same water content. The slump flow is set by, in particular, metered addition of the comb polymer.

The mineral binder composition contains at least one mineral binder. A suitable mineral binder is, in particular, a mineral binder which reacts in the presence of water in a hydration reaction to give solid hydrates or hydrate phases.

This can, in particular, be a hydraulic binder which can be cured by means of water, even underwater, in particular cement, or a latent hydraulic binder which sets in the presence of water under the action of additives, in particular slag sand, or a pozzolanic binder, in particular fly ash or silica dust.

The mineral binder composition preferably comprises at least one hydraulic binder, preferably a cement-type binder.

As cement, it is possible to use any available cement type or a mixture of two or more cement types, for example the cements classified under DIN EN 197-1: Portland cement (CEM I), Portland composite cement (CEM II), blast furnace slag cement (CEM III), pozzolanic cement (CEM IV) and composite cement (CEM V), or the cements classified in the Japanese standard JIS, in particular in JIS R 5210, JIS R 5211, JIS R 5212 or JIS R 5213. Of course, cements which are produced according to an alternative standard, for example the ASTM standard or the Indian standard, are likewise suitable.

Specialty cements such as calcium sulfoaluminate cement and calcium alum inate cement or mixtures thereof, optionally in a mixture with calcium sulfate, are also suitable.

Greatest preference is given to Portland cement or a cement containing Portland cement in accordance with DIN EN 197-1. Portland cement is particularly readily available and makes concrete and mortar having good properties possible.

A Portland cement having a relatively small proportion of C3S and C3A is likewise advantageous. Such cements cure more slowly and components, in particular those having a large volume, produced therewith become less hot during curing, which is advantageous because excessive evolution of heat can lead to cracks.

Preference is given to a proportion of the hydraulic binder, based on the total mineral binder, of at least 5% by weight, in particular at least 20% by weight, more preferably at least 35% by weight, especially at least 65% by weight, with a maximum proportion of 100% by weight. In a further advantageous embodiment, the mineral binder consists to an extent of from 95 to 100% by weight of hydraulic binder, in particular of cement clinker.

It can also be advantageous for the binder composition to contain other binders in addition to or instead of a hydraulic binder. These are, in particular, latent hydraulic binders and/or pozzolanic binders. Suitable latent hydraulic and/or pozzolanic binders are, in particular, slag sand, fly ash and/or silica dust.

In an advantageous embodiment, the mineral binder contains from 5 to 95% by weight, in particular from 10 to 65% by weight, particularly preferably from 15 to 40% by weight, of latent hydraulic and/or pozzolanic binders. Advantageous latent hydraulic and/or pozzolanic binders are slag sand, silica dust and/or fly ash.

In a particularly preferred embodiment, the mineral binder contains a hydraulic binder, in particular cement or cement clinker, and a latent hydraulic and/or pozzolanic binder, preferably slag sand, silica dust and/or fly ash. The proportion of the latent hydraulic and/or pozzolanic binder is preferably from 5 to 65% by weight, particularly preferably from 15 to 40% by weight, while at least 35% by weight, especially at least 60% by weight, of the hydraulic binder are present.

Specialty concretes such as SCC or high performance and ultrahigh performance concretes and mortars are known to a person skilled in the art. They preferably have a high content of mineral binder, in particular more than 350 kg/m³. Good homogeneity, processing properties and/or high strengths can be achieved in this way.

The mineral binder composition mixed with water preferably has a content of mineral binder in the range from 450 to 1600 kg/m³, preferably from 500 to 1500 kg/m³.

In particular, the content of mineral binder is in the range from 450 to 800 kg/m³, preferably from 500 to 700 kg/m³, especially from 550 to 650 kg/m³. Binder compositions having such contents of mineral binder are especially suitable for SCC.

Preference is likewise given to a content of mineral binder in the range from 550 to 1500 kg/m³, more preferably from 650 to 1400 kg/m³, in particular from 700 to 1300 kg/m³, especially from 750 to 1200 kg/m³. Binder compositions having such contents of mineral binder are especially suitable for high performance concrete (HPC) and ultrahigh performance concrete (UHPC) and high performance and ultrahigh performance mortar.

The mineral binder composition preferably contains fine additions. Suitable additions are chemically inert or reactive finely particulate mineral materials such as ground rock, fly ash, silica dust, slag sand, fibers or color pigments. The mineral binder composition preferably additionally contains a rock particle fraction. Such particle fractions are, in particular, chemically inert solid particulate materials and are available in various forms, sizes and as different materials which vary from sand particles to large coarse rocks. In principle, all sands and gravels which are customarily used for concrete and mortar are suitable.

The particle size depends on the use, with particle sizes up to 32 mm and more being suitable.

Preference is given to a maximum particle size of the rock particle fraction of 32 mm, in particular 20 mm, especially 16 mm or 8 mm. Such particle sizes are especially suitable for concrete.

The maximum particle size can, however, also be smaller, preferably not more than 4 mm, in particular 3 mm or 2 mm. Such particle sizes are especially suitable for mortar.

Preference is given to mixing fine additions and rock particle fractions of different particle sizes in order to set the properties of the mineral binder composition in an optimal way. Such mixtures are known to a person skilled in the art.

The mineral binder composition preferably contains a proportion of flour particles of from 450 to 2000 kg/m³, more preferably from 500 to 1800 kg/m³, even more preferably from 550 to 1600 kg/m³. The proportion of mineral binder in the flour particles is preferably at least 60% by weight, in particular at least 80% by weight, with a maximum proportion of 100% by weight.

Such contents of flour particles and binder bring about good cohesion of the mixture and high strengths.

The flour particles preferably have a Blaine fineness of at least 1 000 cm²/g, in particular at least 1 500 cm²/g, preferably at least 2 500 cm²/g, even more preferably at least 3 500 cm²/g or at least 5 000 cm²/g.

The mineral binder composition can comprise at least one additive, for example a concrete admixture and/or a mortar admixture and/or processing chemicals, in addition to the comb polymer K. The at least one additive comprises, in particular, a dispersant, an antifoam, a wetting agent, a dye, a preservative, a plasticizer, a retarder, an accelerator, a polymer, an air pore former, a rheological auxiliary, a viscosity modifier, a pumping aid, a shrinkage reducer or a corrosion inhibitor or combinations thereof.

The mineral binder composition is preferably a mortar or concrete composition, in particular self-compacting concrete, high performance or ultrahigh performance concrete or high performance or ultrahigh performance mortar. The mineral binder composition is, in particular, a processable mineral binder composition which has been mixed with water.

The amount of water with which the mineral binder composition is mixed is preferably very small because too much water has an adverse effect on the strength of a shaped body obtained after curing.

The weight ratio of water to mineral binder is advantageously in the range from 0.10 to 0.40, preferably from 0.11 to 0.35, more preferably from 0.12 to 0.32, in particular from 0.13 to 0.30, especially from 0.14 to 0.28.

Such water-to-binder ratios are especially readily suitable for obtaining high to very high strengths in the concrete.

The weight ratio of water to an amount of flour particles present in the binder composition is preferably in the range from 0.12 to 0.35, preferably from 0.13 to 0.30, in particular from 0.14 to 0.25.

In a preferred embodiment of the invention, the mineral binder composition which has been mixed with water is a high performance concrete (HPC) or ultrahigh performance concrete (UHPC) or a high performance or ultrahigh performance mortar.

In a further preferred embodiment, the mineral binder composition which has been mixed with water is a self-compacting concrete (SCC).

The comb polymer K is advantageously used in a proportion of from 0.01 to 10% by weight, in particular from 0.1 to 7% by weight or from 0.2 to 5% by weight, based on the content of mineral binder.

The comb polymer K comprises a polymer backbone and side chains. In particular, the polymer backbone is essentially linear and has virtually no branches.

The monomer unit M1 comprises acid groups, in particular carboxylic acid, sulfonic acid, phosphoric acid and/or phosphonic acid groups.

The monomer unit M2 bearing side chains preferably comprises polyalkylene oxide side chains, in particular polyethylene oxide and/or polypropylene oxide side chains and/or side chains which are made up of ethylene oxide and propylene oxide.

Preference is given to the monomer unit M1 having the formula I,

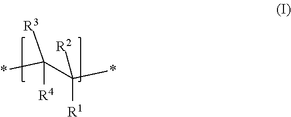

and the monomer unit M2 having the formula II,

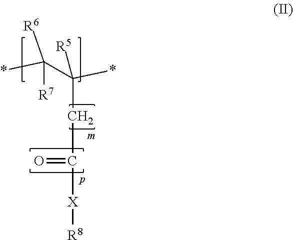

where
the radicals R¹ are each, independently of one another, —COOM, —SO₂—OM, —O—PO(OM)₂ and/or —PO(OM)₂,
R² and R⁵ are each, independently of one another, H, —CH₂COOM or an alkyl group having from 1 to 5 carbon atoms,
R³ and R⁶ are each, independently of one another, H or an alkyl group having from 1 to 5 carbon atoms,
R⁴ and R⁷ are each, independently of one another, H, —COOM or an alkyl group having from 1 to 5 carbon atoms,
or where R¹ together with R⁴ form a ring comprising —CO—O—CO—(anhydride),
the moieties M are, independently of one another, H⁺, an alkali metal ion, an alkaline earth metal ion, a divalent or trivalent metal ion, an ammonium ion or an organic ammonium group;
m=0, 1 or 2,
p=0 or 1,
the moieties X are each, independently of one another, —O—, NH— or —NR⁸—,
the radicals R⁸ are each, independently of one another, a group of the formula -[AO]ₙ—R^{a},
   where A=C₂— to C₄-alkylene, R^{a} is H, a C₁- to C₂₀-alkyl group, -cyclohexyl group or -alkylaryl group,
   and n=2 to 250, in particular from 10 to 200.

Especially advantageous comb polymers K are those in which: R¹ =—COOM; R² and R⁵ are each, independently of one another, H, —CH₃ or mixtures thereof; R³ and R⁶ are each, independently of one another, H or —CH₃, preferably H; R⁴ and R⁷ are each, independently of one another, H or —COOM, preferably H.

In particular, R¹=—COOM, R²=H or CH₃, R³=R⁴=H. The comb polymer K can thus be produced on the basis of acrylic or methacrylic acid monomers, which is of interest from an economic point of view. In addition, such comb polymers in the present context give a short mixing time with a good dispersing action and little delaying of the setting time.

Comb polymers K where R¹=—COOM, R²=H, R³=H and R⁴=—COOM can likewise be advantageous. Such comb polymers can be produced on the basis of maleic acid monomers.

The group X in the monomer unit M2 is advantageously —O—(=oxygen atom) in at least 75 mol %, in particular at least 90 mol %, especially at least 95 mol % or at least 99 mol % of all monomer units M2.

Advantageously R⁵=H or —CH₃, R⁶=R⁷=H and X=—O—. Such comb polymers can, for example, be produced from acrylic or methacrylic esters, vinyl, methallyl, allyl or isoprenol ethers.

In a particularly advantageous embodiment, the radicals R² and R⁵ are each mixtures of from 40 to 60 mol % of H and from 40 to 60 mol % of —CH₃.

In a further advantageous embodiment, R¹=—COOM, R²=H, R⁵=—CH₃ and R³=R⁴=R⁶=R⁷=H.

In another advantageous embodiment, R¹=—COOM, R²=R⁵=H or —CH₃ and R³=R⁴=R⁶=R⁷=H.

The group -[AO]ₙ— in the monomer unit M2 preferably consists, based on all groups -[AO]ₙ— in the comb polymer K, to an extent of at least 50 mol %, in particular at least 75 mol %, preferably at least 95 mol % or at least 99 mol %, of a polyethylene oxide. A proportion of ethylene oxide units based on all alkylene oxide units in the comb polymer K is in particular more than 75 mol %, in particular more than 90 mol %, preferably more than 95 mol % and especially 100 mol %.

In particular, the group -[AO]ₙ— has essentially no hydrophobic groups, in particular no alkylene oxides having three or more carbon atoms. This means, in particular, that a proportion of alkylene oxides having three or more carbon atoms is, based on all alkylene oxides, less than 5 mol %, in particular less than 2 mol %, preferably less than 1 mol % or less than 0.1 mol %. In particular, there are no alkylene oxides having three or more carbon atoms before or the proportion thereof is 0 mol %.

R^{a} is advantageously H and/or a methyl group.

It is particularly advantageous for A=C₂-alkylene and R^{a} to be H or a methyl group.

In particular, the parameter n is from 10 to 150, preferably n=15 to 100, particularly preferably n=17 to 70, especially n=19 to 45 or n=20 to 25. In the mentioned preferred ranges in particular, particularly short mixing times with good processability are achieved thereby.

In a further advantageous embodiment, R¹=COOM, R²=H or —CH₃, R⁵=H or —CH₃, R³=R⁴=R⁶=R⁷=H, m=0, p=1, X=oxygen atom, A=C₂-alkylenes, R^{a}=—CH₃ and n=10 to 115.

Such comb polymers can be produced from acrylic acid and/or methacrylic acid and the ester of acrylic and/or methacrylic acid with a polyethylene oxide terminated at one end by a methoxy group. Monomers having this structure are well suited to producing comb polymers having a nonrandom distribution of the monomers by means of suitable polymerization methods.

A molar ratio of the monomer units M1 to the monomer units M2 in the comb polymer K is advantageously in the range from 0.5 to 6, in particular from 0.7 to 5, preferably from 0.9 to 4.5, more preferably from 1.0 to 4 or from 2 to 3.5. A rapid dispersing action and thus a short mixing time in mineral binder compositions is achieved thereby.

However, other molar ratios can also be advantageous for specific uses.

Furthermore, it can be advantageous for the comb polymer K to comprise at least one further monomer unit MS which is, in particular, chemically different from the monomer units M1 and M2. In particular, a plurality of different further monomer units MS can be present. In this respect, the properties of the comb polymer K can be modified further and, for example, matched to specific uses. The at least one further monomer unit MS is particularly advantageously a monomer unit of the formula III:

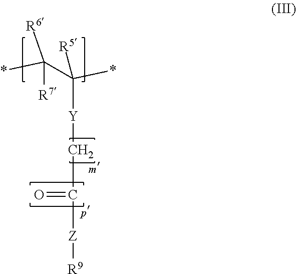

where
R⁵′, R⁶′, R⁷′, m′ and p′ are as defined for R⁵, R⁶, R⁷, m and p;

1Y is, in each case independently, a chemical bond or —O—;
Z is, in each case independently, a chemical bond, —O—or —NH—; the radicals R⁹ are each, independently of one another, H, an alkyl group, cycloalkyl group, alkylaryl group, aryl group, hydroxyalkyl group or an acetoxyalkyl group, in each case having from 1 to 20 carbon atoms.

The at least one further monomer unit MS particularly advantageously consists of copolymerized vinyl acetate, styrene and/or hydroxyalkyl (meth)acrylate, in particular hydroxyethyl acrylate.

The monomer unit MS is advantageously present in an amount of from 0 to 50 mol %, preferably from 1 to 40 mol %, especially from 2 to 30 mol %, in particular from 5 to 20 mol %, based on the sum of all monomer units in the comb polymer K.

In particular, the comb polymer K consists to an extent of at least 50 mol %, in particular at least 75 mol %, especially at least 90 mol % or 95 mol %, of monomer units M1 and monomer units M2.

A plurality of different monomers units M1 of the formula I and/or a plurality of different monomer units M2 of the formula II can be present in the comb polymer K.

The comb polymer K preferably has a polydispersity of less than 1.5, preferably in the range from 1.0 to 1.4, in particular in the range from 1.1 to 1.3. For the purposes of the present invention, the polydispersity is the ratio of weight average molecular weight Mw to number average molecular weight Mn, both in g/mol.

The weight average molecular weight M_{W} of the total comb polymer K is in particular in the range from 8 000 to 100 000 g/mol, advantageously from 10 000 to 80 000 g/mol, especially from 12 000 to 50 000 g/mol. In the present context, molecular weights such as the weight average molecular weight M_{W} and the number average molecular weight Mn are determined by gel permeation chromatography (GPC) using polyethylene glycol (PEG) as standard.

The monomer units M1 and M2 are arranged in a nonrandom sequence along the polymer backbone in the comb polymer K.

Here, at least one monomer unit M1 or M2 is present in an increased concentration in at least one section of the polymer chain.

In an advantageous embodiment, the comb polymer K consists of at least one section A in which the monomer unit M1 or the monomer unit M2 occurs in an increased concentration in the section A.

The monomer unit M1 which comprises acid groups is advantageously present in an increased concentration in at least one section. As a result, the comb polymer K has a high charge density in this section, which is especially advantageous for a short mixing time.

It is likewise advantageous for the monomer unit M2 which comprises side chains to be present in an increased concentration in at least one section. This enables a high density of side chains to be achieved locally, which can bring about a particularly good steric dispersing action.

In particular, the comb polymer K comprises a section A in which preferably at least 30 mol %, more preferably at least 40 mol %, in particular at least 50 mol %, especially at least 60 mol %, of all monomer units M1 are present in built-in form and no monomer units M2 are built in in this section. However, it can likewise be advantageous for at least 30 mol %, more preferably at least 40 mol %, in particular at least 50 mol %, especially at least 60 mol %, of all monomer units M2 to be present in the section A and no monomer units M1 to be built in in this section.

In particular, both the monomer unit M1 and the monomer unit M2 is present in increased concentration in at least one section.

In another advantageous embodiment, the comb polymer K consists of the at least one section A in which the monomer unit M1 occurs in an increased concentration in the section A and of a further section B in which the monomer unit M2 occurs in an increased concentration in the section B.

A short mixing time together with a very good dispersing action can be achieved thereby.

However, it is also possible, for example, for the comb polymer K to contain at least two different sections A and/or to contain at least two different further sections B.

In a preferred embodiment, the comb polymer K contains monomer units MS, with the monomer unit MS being able to be present in every section of the comb polymer K. It is preferably present randomly built-in in the respective section.

The monomer unit MS is, however, also advantageously present in an increased concentration in one section, for example to spatially separate sections in which either the monomer unit M1 and/or the monomer unit M2 is/are each present in an increased concentration from one another.

The structure of copolymers can be analyzed and determined by means of nuclear magnetic resonance spectroscopy (NMR spectroscopy). ¹³C-NMR and ¹H-NMR spectroscopy, in particular, enable the sequence of monomer units in the copolymer to be determined in a manner known per se on the basis of neighboring group effects in the copolymer and on the basis of statistical evaluations.

In a preferred embodiment, the comb polymer K is a block copolymer or a copolymer having a gradient structure. Illustrative block copolymers are described in WO2015/144886 and illustrative gradient polymers are described in WO 2017/050907.

The comb polymer K is advantageously a block copolymer and comprises at least one first section A′ and at least one second section B′, with the first section A′ comprising the monomer unit M1 and the second section ′ comprising the monomer unit M2 and any proportion of monomer units M2 present in the first section A′ being less than 25 mol %, in particular less than or equal to 10 mol %, based on all monomer units M1 in the first section A′, and any proportion of monomer units M1 present in the second section B′ being less than 25 mol %, in particular less than or equal to 10 mol %, based on all monomer units M2 in the second section B′.

The sections A′ and B′ can have identical or different numbers of monomer units. It is advantageous for the sections A′ and B′ not to have the same size. In this way, the structure of the comb polymer can be varied in a targeted manner.

The monomer units M1 and any further monomer units in the first section A′ are, in particular, statistically or randomly distributed. Likewise, the monomer units M2 and any further monomer units in the second section B′ are, in particular, statically or randomly distributed.

In other words, the at least one section A′ and/or the at least one section B′ is/are preferably present in each case as partial polymer having a random monomer distribution.

The at least one first section A′ advantageously comprises from 5 to 70, in particular from 7 to 40, preferably from 10 to 25, monomer units M1 and/or the at least one second section B′ comprises from 5 to 70, in particular from 7 to 40, preferably from 10 to 25, monomer units M2.

In a further preferred embodiment, the first section A′ comprises from 25 to 35 monomer units M1 and/or the at least one second section B′ comprises from 10 to 20 monomer units M2.

It is likewise advantageous for the comb polymer K to be a gradient polymer and to have a gradient structure in respect of the monomer unit M1 and/or the monomer unit M2 in at least one section A″ in a direction along the polymer backbone.

In other words, the gradient polymer has a concentration gradient in respect of the monomer unit M1 and/or in respect of the monomer unit M2 in the at least one section A″ in a direction along the polymer backbone. For the present purposes, the expression “gradient structure” or “concentration gradient” refers, in particular, to a continuous change in the local concentration of a monomer unit in at least one section in a direction along the backbone of the copolymer. Another term for “concentration gradient” is “concentration slope”.

Preference is given to a local concentration of the at least one monomer unit M1 increasing continuously along the polymer backbone and a local concentration of the at least one monomer unit M2 decreasing continuously along the polymer backbone, or vice versa, in the at least one section A″. In particular, a local concentration of the monomer unit M1 at the first end of the at least one section A″ is lower than at the second end of the section A″, while a local concentration of the monomer unit M2 at the first end of the section A″ is greater than at the second end of the section A″, or vice versa.

The at least one section A″ advantageously has, based on a total number of monomer units in the polymer backbone, a proportion of at least 30%, in particular at least 50%, preferably at least 75% or 90%, of monomer units.

The comb polymer K preferably has, in addition to the at least one section A″ which has a gradient structure, a further section B″ in which there is an essentially constant local concentration of the monomers and/or a statistical or random distribution of the monomers over the total section B″. Section B″ can, for example, consist of monomers of a single type or of a plurality of different monomers which are randomly distributed. However, particular preference is given to there being no gradient structure or no concentration gradient along the polymer backbone in the section B″.

The comb polymer K can also have more than one further section B″, e.g. two, three, four or even more sections B″, which can differ chemically and/or structurally.

Preference is given to the at least one section A″ directly adjoining the further section B″.

The comb polymer K can advantageously be produced by a controlled free-radical polymerization and/or by a living free-radical polymerization of appropriate monomers m1, m2 and ms which form the monomer units M1, M2 and MS in the polymer.

The techniques for controlled free-radical polymerization and/or living free-radical polymerization are, inter alia, nitroxide-mediated polymerization (NMP), atom transfer radical polymerization (ATRP) or reversible addition fragmentation chain transfer polymerization (RAFT). Preference is given to RAFT polymerization.

Suitable production methods and illustrative comb polymers K are described in WO2015/144886 and WO 2017/050907.

Living free-radical polymerization is carried out essentially in the absence of irreversible chain transfer or termination reactions. The number of active chain ends is small and remains essentially constant during the polymerization. This is achieved in the case of, for example, RAFT polymerization by the use of an RAFT agent and an amount of initiator which is not too small. This makes essentially simultaneous growth of the chains which is maintained during the entire polymerization process possible. This makes it possible to produce block or gradient polymers by means of this process and a narrow molecular weight distribution or polydispersity of the polymer is correspondingly obtained. This is not possible in conventional “free-radical polymerization” or free-radical polymerization carried out under nonliving or uncontrolled conditions.

In one suitable reaction, the monomer m1 or the monomer m2 is polymerized by means of an initiator, in particular azobisisobutyronitrile (AIBN), α,α′-azodiisobutyram idine dihydrochloride (AAPH) or azobisisobutyramidine (AIBA), in the presence of a RAFT agent, in particular a dithioester, dithiocarbamate, trithiocarbonate or xanthate, in water under an inert gas atmosphere at from 70 to 95° C. to a reaction conversion of from 60 to 80 mol % in a first step a) and the respectively other monomer, m2 or m1, is subsequently added in a further step b). The addition of the other monomer can be carried out in one step or continuously over a certain period of time or else stepwise. This reaction gives a comb polymer K which consists of a section containing the monomer unit M1 and no monomer units M2 or vice versa and a further section which contains the second monomer in an increased concentration and in which the two monomers are present randomly or arranged in gradient form. This makes it possible to obtain advantageous comb polymers K containing exclusively monomer unit M1 or M2 in a section at one end of the polymer chain.

The optional monomer ms can be added as early as in the first reaction step a), together with monomer m1 or the monomer m2, or in the further reaction step b), together with the second monomer m2 or m1, or in a reaction step c) inserted between reaction step a) and reaction step b), or subsequently to reaction step b) in a reaction step c′).

The reaction conversion can here be determined, for example, by means of high performance liquid chromatography (HPLC) via the decrease in the monomer concentrations in the polymerization solution. Such methods are known to a person skilled in the art.

A preferred comb polymer K can, for example, be produced by living free-radical polymerization, in particular by RAFT polymerization, of acrylic acid and/or methacrylic acid as monomer ml with methoxypolyethylene glycol methacrylate as monomer m2 and optionally hydroxyethyl acrylate or hydroxyethyl methacrylate as monomer ms. The methoxypolyethylene glycol methacrylate preferably contains from 10 to 115 oxyethylene units. The molar ratio of m1:m2:ms in the reaction is preferably 1.5-4:1:0-3.

The reaction is preferably carried out in water under a protective gas atmosphere, in particular under N₂ or Ar, at a temperature of from 70° C. to 95° C.

It can be advantageous for the mineral binder composition to contain at least one further dispersant in addition to the comb polymer K.

In this way, further properties of the mineral binder composition, for example the processability and processing window, can be set in a targeted way. Such blends are also economically useful.

The at least one further dispersant is preferably a plasticizer for concrete or mortar. Suitable plasticizers are, for example, lignosulfonates, sulfonated naphthalene-formaldehyde condensates, sulfonated melamine-formaldehyde condensates, phenol condensates containing polyalkylene oxide chains and acid groups, sulfonated vinyl copolymers, polyalkylene glycols having phosphonate groups, polyalkylene glycols having phosphate groups, polycarboxylates or comb polymers having anionic groups and polyether side chains. In particular, the at least one further dispersant is a further comb polymer. The further comb polymer preferably has anionic groups and polyalkylene oxide side chains, with the anionic groups being selected from among carboxylate groups, sulfonate groups, phosphonate groups or phosphate groups and the monomer units of the further comb polymer being arranged purely randomly along the polymer backbone.

A preferred further comb polymer is a comb polymer which has been produced by means of conventional free-radical copolymerization or by means of polymer-analogous esterification/amidation and comprises carboxylate groups and side chains composed of polyethylene oxide which are bound by ester, ether, imide and/or amide groups to the polymer backbone.

The mineral binder composition preferably contains an additional dispersant, preferably a further comb polymer, with the monomer units of the further comb polymer being distributed purely randomly along the polymer backbone.

The comb polymer K and the further dispersant are preferably present in a blend before they are added to the mineral binder composition.

The combination of the comb polymer K with the further dispersant makes it possible to achieve a greatly shortened mixing time together with very good processability.

The mixing ratio of comb polymer K to the further dispersant is preferably from 10:1 to 1:10, more preferably from 5:1 to 1:5, in particular from 3.5:1 to 1:3.5, based on dry polymers.

The comb polymer K can be present in liquid or solid form. The comb polymer K is particularly preferably present as constituent of a solution or dispersion in which a proportion of the comb polymer K is, in particular, from 10 to 90% by weight, preferably from 20 to 65% by weight, or from 25 to 50% by weight. This makes it possible, for example, to add the comb polymer K very readily to binder compositions.

However, other proportions of the comb polymer K can also be advantageous, especially in combination with the further dispersant. Thus, a solution or dispersion can have a proportion of 20% by weight of comb polymer K and from 5 to 10% by weight of further dispersant, or 15% by weight of comb polymer K and 30% by weight of further dispersant, or 10% by weight of comb polymer K and from 10 to 20% by weight of further dispersant.

In another advantageous embodiment, the comb polymer K is present in the solid state, in particular in the form of a powder, in the form of pellets or in the form of plates. Transport, in particular, is simplified in this way. The powder can be added to the dry binder composition, the wet binder composition or the mixing water.

The comb polymer K can advantageously be present blended with the further dispersant in the powder.

In particular, the comb polymer K can be added as powder to a finished dry concrete or mortar mixture.

Such polymer powders are obtainable by drying, in particular spray drying, of an aqueous polymer solution or dispersion or by milling of a solidified polymer melt. Here, additions, for example stabilizers, in particular oxidation stabilizers, or support materials can be added to the polymer so as to increase the storage stability of the powder.

In a further aspect, the invention provides a process for producing a concrete or mortar by mixing a dry mineral binder composition with water and a comb polymer K as described above, characterized in that the mixing time of the binder composition containing the comb polymer K is reduced, preferably by at least 20%, in particular by at least 25%, especially by at least 30%, compared to the mixing time of a mineral binder composition containing a comb polymer having a random sequence of the monomer units along the polymer backbone and no comb polymer K, where the binder compositions mixed with water have an identical composition except for the comb polymer and a comparably good processability after the end of the mixing time.

The mixing of a dry mineral binder composition with water and a comb polymer K as described above can be carried out continuously or batchwise. Suitable mixing apparatuses are known per se to a person skilled in the art. Mixing apparatuses can contain dynamic and/or static mixing elements. In a preferred embodiment, use is made of static mixers. In a further preferred embodiment, dynamic mixing apparatuses which are divided into a section for transport and a section for mixing of the material being mixed are used.

Examples of suitable mixing apparatuses are horizontal single-screw mixers, double-screw mixers, vertical mixers, belt mixers, circumferential mixers, tumble shakers, Hobart mixers, planetary mixers, concrete mixers, drum mixers, mixing buckets, mixing tubes, paddle mixers, jet mixers and screw mixers.

In particular, the weight ratio of water to mineral binder in the process for producing the concrete or mortar in short mixing times is in the range from 0.10 to 0.40, preferably from 0.11 to 0.35, more preferably from 0.12 to 0.32, in particular from 0.13 to 0.30, especially from 0.14 to 0.28, and/or the weight ratio of water to an amount of flour particles present in the binder composition is in the range from 0.12 to 0.35, preferably from 0.13 to 0.30, in particular from 0.14 to 0.25.

In particular, the mineral binder composition mixed with water has a content of mineral binder of more than 350 kg/m³, preferably from 450 to 1600 kg/m³, a content of flour particles of from 450 to 2000 kg/m³ and a weight ratio of water to mineral binder of from 0.1 to 0.4.

Such concretes and mortars achieve especially good strengths and the effect of the comb polymer K for shortening the mixing time is particularly pronounced in such mixtures.

In a further aspect, the invention provides a mineral binder composition mixed with water, in particular a self-compacting concrete (SCC), a high performance concrete (HPC), an ultrahigh performance concrete (UHPC) or a high performance or ultrahigh performance mortar, containing at least one comb polymer K as described above.

An additional aspect of the present invention provides a shaped body, in particular a constituent of a construction, obtainable by curing a mineral binder composition as described above.

A construction can be, for example, a bridge, a building, a tunnel, a road or a runway.

Further advantageous embodiments of the invention can be derived from the following working examples.

### EXAMPLES

1. Determination of molecular weight and Polydispersity of the Polymers and also the Solids Content of the Polymer Solutions

The weight average molecular weight M_{W} and the polydispersity of the polymers were determined by gel permeation chromatography (GPC) using polyethylene glycol (PEG) as standard.

Column cascade used: three 8×300 mm Suprema GPC columns (10 μm, 2×1000 Å, 1×30 Å, with precolumn), from PSS Polymer Standards Service, Germany

Eluent: 0.1N NaNO₃ solution, the pH of which has been set to 12 by means of NaOH

Flow rate: 0.8 ml/min

Detector: RI detector 2414 from Waters, USA

Temperature of column ovens and detector: 45° C.

The evaluation was carried out using the evaluation software Waters® Breeze™ 2 (Waters, USA) as method relative to polyethylene oxide standard (PSS Polymer Standards Service, Germany).

The solids content of the polymer solutions was determined using a halogen drier model HG 63 from Mettler Toledo, Switzerland.

2. Production of the Polymers

2.1 Block Copolymer P1

To produce the block copolymer P1 by means of RAFT polymerization, 57.4 g of a 50% strength by weight aqueous solution of methoxypolyethylene glycol 1000 methacrylate (0.03 mol; average molecular weight of the polyethylene glycol ˜1 000 g/mol) and 30.1 g of deionized water were placed in a round-bottom flask equipped with a reflux condenser, stirrer, thermometer and an inert gas inlet tube. The reaction mixture was heated to 80° C. while stirring vigorously. A gentle inert gas stream (N₂) was passed through the solution during heating-up and the entire remaining reaction time.

756 mg of 4-cyano-4-(thiobenzoyl)pentanoic acid (2.7 mmol; RAFT agent) were then added to the mixture. After the substance had completely dissolved, 135 mg of azobisisobutyronitrile (0.82 mmol; initiator) were added. From then on, the conversion was determined at regular intervals by means of HPLC.

As soon as the conversion, based on methoxypolyethylene glycol methacrylate, was more than 80 mol %, 9.32 g of methacrylic acid (0.11 mol) were added to the reaction mixture. The mixture was allowed to react for a further 2 hours and subsequently to cool. A clear, slightly reddish, aqueous solution remained. The solids content of the solution was set to 30% by weight by addition of water.

The molar ratio of methacrylic acid to methoxypolyethylene glycol methacrylate is 3.7. The molecular weight M_{W} of the polymer is 24 000 g/mol and the polydispersity is 1.2.

2.2 Random Copolymer P2

22 g of methoxypolyethylene glycol 1000 methacrylate (0.021 mol, average molecular weight of the polyethylene glycol ˜1 000 g/mol), 129 g of methoxypolyethylene glycol 3000 methacrylate (0.042 mol, average molecular weight of the polyethylene glycol ˜3 000 g/mol), 26.6 g (0.37 mol) of acrylic acid and 188 g of water were mixed in a reservoir. In a second reservoir, 1.9 g (0.01 mol) of Na₂S₂O₅ were dissolved in 25 g of water, and 2.4 g (0.01 mol) of Na₂S₂O₈ were dissolved in 25 g of water in a third reservoir. 100 g of water were placed in a multineck flask provided with reflux condenser, mechanical stirrer, thermometer and inlet for the solutions and heated to 90° C. While stirring and heating to 85-90° C., the solutions from the reservoirs were metered in simultaneously and uniformly via separate inlets over a period of 4 hours by means of metering pumps. After the metered addition was complete, the reaction mixture was stirred at 85-90° C. for a further 30 minutes. After cooling, the pH of the solution was set to 5 by addition of a 30% strength by weight NaOH solution. The solids content of the solution was set to 30% by weight by addition of water.

The molar ratio of acid monomer to methoxypolyethylene glycol methacrylate is 5.9. The molecular weight M_{W} of the polymer is 32 000 g/mol and the polydispersity is 2.4.

2.3 Random Copolymer P3

Copolymer P3 was obtained by polymer-analogous esterification of a copolymer of acrylic acid and methacrylic acid (average molecular weight Mw of about 4 000) with methoxypolyethylene glycol 3000 (polyethylene glycol terminated at one end by a methoxy group and having an average molecular weight Mw of 3000). The solids content of the solution was set to 30% by weight by addition of water.

The molar ratio of acid groups to polyethylene glycol chains in the polymer is 4.5. The molecular weight M_{W} of the polymer is 48 000 g/mol and the polydispersity is 2.4.

2.4 Random Copolymer P4

Copolymer P4 was obtained by polymer-analogous esterification of a copolymer of acrylic acid and methacrylic acid (average molecular weight Mw of about 4 000) with methoxypolyethylene glycol 1000 (polyethylene glycol terminated at one end by a methoxy group and having an average molecular weight Mw of 1000) and methoxypolyethylene glycol 3000 (polyethylene glycol terminated at one end by a methoxy group and having an average molecular weight Mw of 3000). The solids content of the solution was set to 20% by weight by addition of water.

The molar ratio of acid groups to polyethylene glycol chains in the polymer is about 1.6. The molecular weight M_{W} of the polymer is 30 000 g/mol and the polydispersity is 2.6.

3. Tests in concrete mixtures

3.1 Production of the concrete mixture and measurement methods for trial 1 and trial 2

Concrete production: Cement, silica dust, sand and gravel were mixed for 15 seconds in a twin-screw mixer and the water in which the polymer had been dissolved was subsequently added. The concrete was subsequently mixed until a homogeneous, readily flowing consistency had been attained and the mixing time required for this was noted. The fresh concrete properties were subsequently determined. All concrete mixtures were prepared using one and the same concrete mixer.

The mixing time was determined as follows:

After addition of the water containing the comb polymer, the concrete was mixed for 60 seconds and the homogeneity and consistency were determined visually and by means of shoveling by hand. If necessary, mixing was continued and the homogeneity and consistency was tested at regular intervals. In this way, it was assessed whether the mixture was dry or moist, inhomogeneous or homogeneous or stiff or soft and flowable. The mixing time is the time interval between the addition of water and attainment of homogeneous, soft and flowable consistency of the concrete, with only the pure mixing time without stoppage times being counted.

The air content of the concrete mixture was determined in accordance with JIS A 1128.

The slump flow was determined in accordance with JIS A 1150.

The 50 cm flow time is determined together with the slump flow and is the time required by the concrete in order to attain a diameter of 50 cm after lifting up the slump cone.

The L-flow test indicates the flow velocity of the concrete and is a measure of the concrete viscosity. It was measured in accordance with JSCE-F-514.

Setting commencement and end of setting of the concrete were determined by means of a penetration test in accordance with JIS A 1147 on a mortar sample obtained by sieving of the concrete.

3.2 Trial 1

The concrete mixture used for test purposes in trial 1 has the composition described in Table 1.

TABLE 1

| Component | kg/m³ |
|---|---|
| Moderate heat cement* | 1030 |
| Silica dust | 77 |
| Crushed sand having a fineness modulus of | 350 |
| 3.01 | |
| Gravel having a maximum size of 20 mm | 863 |
| Water (including the comb polymer solution) | 155 |
| Antifoam | 0.03 |
| Comb polymer corresponding to Table 2 | As per Table 2 |

*Cement having a low heat of hydration (low content of C3S)

Table 2 shows the comb polymers used and the amounts thereof which are added and also the mixing times required for homogeneous mixing and the fresh concrete properties of the concrete mixtures.

TABLE 2

| | Point in time of | | | | |
|---|---|---|---|---|---|
| | measurement** | | Reference 1 | Example 1 | Example 2 |
| Polymer | | | P2 | P1 | P1 |
| Amount added (%)* | | | 1.6 | 1.6 | 1.26 |
| Mixing time (min.) | | | 9 | 5 | 5 |
| Reduction in the mixing | | | — | 56 | 56 |
| time compared to the | | | | | |
| reference (%) | | | | | |
| Slump flow (cm) | 0 | min | 65 | 79 | 73 |
| | 30 | min | 66 | | 72 |
| | 60 | min | 67 | | 69 |
| 50 cm flow time (sec.) | 0 | min | 22.9 | 9.7 | 16.6 |
| | 30 | min | 30.2 | | 21.0 |
| | 60 | min | 34.2 | | 27.6 |
| L-flow test (cm/sec.) | 0 | min | 2.7 | 6.8 | 4.2 |
| Air (%) | 0 | min | 1.4 | 1.3 | 1.3 |
| Setting commencement | | | 11:15 | 14:40 | 11:10 |
| (hh:mm) | | | | | |
| End of setting (hh:mm) | | | 12:40 | 15:45 | 12:30 |

*% by weight of polymer solution based on weight of binder (cement plus silica dust)
**time elapsed after end of mixing

3.3 Trial 2

The concrete mixture used for test purposes in trial 2 has the composition described in Table 3.

TABLE 3

| Component | kg/m³ |
|---|---|
| Moderate heat cement* | 773 |
| Crushed sand having a fineness modulus of | 678 |
| 3.01 | |
| Gravel having a maximum size of 20 mm | 819 |
| Water (including the comb polymer solution) | 170 |
| Antifoam | 0.03 |
| Comb polymer solution corresponding to Table | As per Table 4 |
| 4 | |

*Cement having a low heat of hydration (low content of C3S)

Table 4 shows the comb polymers used and the amounts thereof which are added and also the mixing times required for homogeneous mixing and the fresh concrete properties of the concrete mixtures.

TABLE 4

| | Point in time of | | | |
|---|---|---|---|---|
| | measurement** | Reference2 | Example3 | Example4 |
| Polymer | | P3 | P1 | P1 |
| Amount added (%)* | | 1.14 | 1.14 | 0.95 |
| Mixing time (min.) | | 4.0 | 2.5 | 2.5 |
| Reduction in the mixing | | — | 62.5 | 62.5 |
| time compared to the | | | | |
| reference (%) | | | | |
| Slump flow (cm) | 0 min | 67 | 90 | 79 |
| 50 cm flow time (sec.) | 0 min | 6.7 | 5.1 | 7.3 |
| Air (%) | 0 min | 1.2 | 0.5 | 0.5 |
| Setting commencement | | 4:55 | n.m. | 3:50 |
| (hh:mm) | | | | |
| End of setting (hh:mm) | | 7:09 | n.m. | 6:00 |

*% by weight of polymer solution based on weight of cement
**time elapsed after end of mixing
n.m. . . . not measured

3.4 Production of the Concrete Mixture and Measurement Methods for Trial 3

Concrete production: Cement, slag sand, silica dust and sand were mixed for 30 seconds in a mechanical mixer and the water in which the polymer had been dissolved was subsequently added. The concrete was subsequently mixed for 6 or 3 minutes, as shown in Table 6. The fresh concrete properties were subsequently determined. All concrete mixtures were prepared using one and the same concrete mixer.

The slump flow was determined in accordance with DIN-EN 12350-2 immediately after mixing and after 30 minutes.

The homogeneity of the mixture after the prescribed mixing time was assessed visually and evaluated with grades from 1 to 5, where 1 means inhomogeneous and 5 means completely homogeneous.

The processability of the mixture after the prescribed mixing time was assessed by manual shoveling of the concrete and assessment of the resistance and the viscosity and evaluated with grades from 1 to 5, where 1 means very hard and viscous and 5 means very soft and with good flow and the values 2, 3 and 4 mean corresponding intermediate stages.

3.5 Trial 3

The concrete mixture used for test purposes in trial 3 has the composition described in Table 5.

TABLE 5

| Component | kg/m³ |
|---|---|
| Cement (CEM I 42.5) | 325 |
| Slag sand | 150 |
| Silica dust | 50 |
| Sand 0-16 mm (contains 6.4% by weight of | 1760 |
| particles below 0.125 mm) | |
| Water* | 140 |
| Comb polymer solution corresponding to | As per Table 6 |
| Table 6 | |

*including the comb polymer solution

Table 6 shows the comb polymers used and the amounts thereof which are added and also the mixing times and the fresh concrete properties of the concrete mixtures.

TABLE 6

| | Reference 3 | Example 5 |
|---|---|---|
| Amount of polymer P1 | 0 | 2.75 |
| added (%)* | | |
| Amount of polymer P3 | 2.75 | 0 |
| added (%)* | | |
| Amount of polymer P4 | 1.3 | 1.3 |
| added (%)* | | |
| Mixing time wet (min.) | 6 | 3 |
| Slump flow immediate (cm) | 69 | 78 |
| Slump flow after 30 min. (cm) | 70 | 70 |
| Processability | 2 | 2 |
| Homogeneity | 5 | 5 |

*% by weight of polymer solution based on weight of cement

1. A method for shortening a mixing time of a mineral binder composition with water, the method comprising:
adding water to a dry mineral binder composition and a comb polymer K, and attaining a homogeneous mixture, where the mixining time is the time interval be the addition of the water to the dry mineral binder composition and the comb olymer K, and the attainment of the homogeneous mixture, and the mixing time is shortened compared to the mixing time of an identical mineral binder composition containing a comb polymer having a random sequence of the monomer units along the polymer backbone and none of the comb polymer K, and where the homogeneous mixture and the identical mineral binder composition without the comb polymer K have a comparable processability after the end of the respective mixing time necessary to obtain homogeneity; wherein
the comb polymer K comprises a polymer backbone and side chains,
the comb polymer K comprises at least one monomer unit M1 comprising acid groups and at least one monomer unit M2 comprising side chains, and
the at least one monomer units M1 and M2 are arranged in a nonrandom sequence along the polymer backbone.

2. The method as claimed in claim 1, wherein the mixing time is shortened by at least 20%.

3. The method as claimed in claim 1, wherein the homogeneous mixture has a content of mineral binder in the range from 450 to 1600 kg/m³.

4. The method as claimed in claim 1, wherein a weight ratio of water to a mineral binder is in the range from 0.10 to 0.40.

5. The method as claimed in claim 1, wherein the dry mineral binder composition comprises flour particles, and the weight ratio of water to an amount of the flour particles present in the homogeneous mixture is in the range from 0.12 to 0.35.

6. The method as claimed in claim 1, wherein the homogeneous mixture is a high performance or ultrahigh performance concrete or a high performance or ultrahigh performance mortar.

7. The method as claimed in claim 1, wherein the homogenous mixture is a self-compacting concrete.

8. The method as claimed in claim 1, wherein the at least one monomer unit M1 has the formula I, 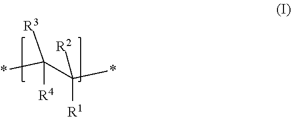
and the at least one monomer unit M2 has the formula II, 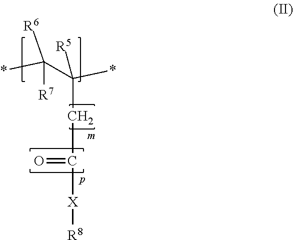
where
the radicals le are each, independently of one another, —COOM, —SO₂—OM, —O—PO(OM)₂ and/or —PO(OM)₂,
R² and R⁵ are each, independently of one another, H, —CH₂COOM or an alkyl group having from 1 to 5 carbon atoms,
R³ and R⁶ are each, independently of one another, H or an alkyl group having from 1 to 5 carbon atoms,
R⁴ and R⁷ are each, independently of one another, H, —COOM or an alkyl group having from 1 to 5 carbon atoms,
or where R¹ together with R⁴ form a ring comprising —CO—O—CO— (anhydride),
the moieties M are, independently of one another, H⁺, an alkali metal ion, an alkaline earth metal ion, a divalent or trivalent metal ion, an ammonium ion or an organic ammonium group;
m=0, 1 or 2,
p=0 or 1,
the moieties X are each, independently of one another, —O—, NH— or —NR⁸—, the radicals R⁸ are each, independently of one another, a group of the formula -[AO]ₙR^{a},
where A=C₂- to C₄-alkylene, R^{a} is H, a to C₂₀-alkyl group, -cyclohexyl group or -alkylaryl group,
and n=2 to 250.

9. The method as claimed in claim 1, wherein a molar ratio of the at least one monomer unit M1 to the at least one monomer unit M2 in the comb polymer K is in the range from 0.5 to 6.

10. The method as claimed in claim 1, wherein the comb polymer K has a polydispersity of less than 1.5.

11. The method as claimed in claim 1, wherein the comb polymer K is a block copolymer or a copolymer having a gradient structure.

12. The method as claimed in claim 1, wherein the mineral binder composition further comprises at least one member selected from the group consisting of a dispersant and a further comb polymer, where the monomer units of the further comb polymer are distributed purely randomly along the polymer backbone.

13. A process for producing a concrete or mortar, the process comprising;
mixing a dry mineral binder composition with water and a comb polymer K to form a homogeneous binder composition, wherein the comb polymer K comprises a polymer backbone and side chains, where the comb polymer K comprises at least one monomer unit M1 comprising acid groups and at least one monomer unit M2 comprising side chains, wherein the at least one monomer units M1 and M2 are arranged in a nonrandom sequence along the polymer backbone; wherein
a mixing time of the homogenous binder composition containing the comb polymer K is reduced, by at least 20%, in particular by at compared to a mixing time of a mineral binder composition containing a comb polymer having a random sequence of the monomer units along the polymer backbone and no comb polymer K, where the homogenous binder composition and the mineral binder composition with no comb polymer K have an identical composition except for the comb polymer and have a comparable processability after the end of the respective mixing time necessary to obtain homogeneity, where the homogenous binder composition is a self-compacting concrete, a high performance concrete, an ultrahigh performance concrete or a high performance or ultrahigh performance mortar, wherein the homogenous binder composition has a content of mineral binder of more than 350 kg/m³, a content of flour particles of from 450 to 2000 kg/m³ and a weight ratio of water to mineral binder of from 0.1 to 0.4.

14. A mineral binder composition mixed with water, the mineral hinder composition containing at least one comb polymer K, wherein the mineral binder composition is a self-compacting concrete, a high performance concrete, an ultrahigh performance concrete or a high performance or ultrahigh performance mortar, wherein the mineral binder composition mixed with water has a content of mineral binder of more than 350 kg/m³, a content of flour particles of from 450 to 2000 kg/m³ and a weight ratio of water to mineral binder of from 0.1 to 0.4: wherein the at least one comb polymer K comprises a polymer backbone and side chains where the at least one comb polymer K comprises at least one monomer unit M1 comprising acid groups and at least one monomer unit M2 comprising, side chains, wherein the at least one monomer units M1 and M2 are arranged in a nonrandom sequence along the polymer backbone.

15. A shaped body, the shaped body being obtained by curing the mineral binder composition as claimed in claim 14.
